(19) United States
(12) Patent Application Publication
(10) Pub. No.: US 2024/0050970 A1
(43) Pub. Date: Feb. 15, 2024

(54) PUMP DISPENSER

(71) Applicant: ALPLA WERKE ALWIN LEHNER GMBH & CO. KG, Hard (AT)

(72) Inventor: Roland Knauer, Sonneberg (DE)

(21) Appl. No.: 18/259,073

(22) PCT Filed: Dec. 22, 2021
(86) PCT No.: PCT/EP2021/087417

§ 371 Date: Jun. 22, 2023

(30) Foreign Application Priority Data
Dec. 22, 2020 (CH) 01658/20

(51) Int. Cl. B05B 9/04; B05B 12/00

(52) U.S. Cl. CPC B05B 9/0413; B05B 12/002

(57) ABSTRACT

A pump dispenser for metered removal of a liquid from a container includes a housing for placement on the container to form a metering chamber, a rising tube connected to the metering chamber, and a pump head movable relative to the housing along a longitudinal axis of the dispenser to carry out a pump stroke. The pump dispenser has a piston secured to the pump head that is movable in the metering chamber to convey the liquid, a dispenser opening is connected to the metering chamber through which metered liquid can leave the pump dispenser, a spring that resets the pump head relative to the housing, and a valve that defines a conveying direction of the liquid from the rising tube into the dispenser opening and that blocks a conveying process in the opposite direction. The spring has a plurality of rings connected by respective connecting webs.

### CROSS-REFERENCE TO RELATED APPLICATIONS

This application is a national phase entry under 37 U.S.C § 371 of PCT/EP2021/087417 filed Dec. 22, 2021, which claims priority to Swiss Patent Application No. 01658/20 filed Dec. 22, 2020, the entirety of each of which is incorporated by this reference.

### FIELD OF THE INVENTION

The invention relates to a pump dispenser for metered removal of a liquid from a container, and a pump container comprising such an attached pump dispenser.

### PRIOR ART

Pump dispensers are used for the metered removal of a liquid, which can also have an increased viscosity (creams or gels), from a storage container by depressing a dispenser head. The dispenser extension is formed on the dispenser head and therefore moves along with the dispenser head. A metal spring is integrated into the dispenser for returning the dispenser head to its previous position. The valve function, which is necessary for the liquid to be conveyed into the dispenser extension when the head is pressed, and for the liquid to be sucked back into the pump dispenser when the head is returned, is realized by metal or glass balls.

Type-sorted disposal of such pump dispensers known from the prior art is not possible or is only possible with a very great deal of effort, since the metal spring and the valve balls would have to be removed from the pump dispenser. It is also impractical for the dispenser extension to move along with the head since liquid thus often misses its target (e.g., the hand of a user) and contaminates the surroundings of the target.

### Advantages of the Invention

The disadvantages of the prior art described give rise to a metering dispenser that can be emptied in a homogeneous manner.

Another advantage is a metering dispenser with improved function and that is more user-friendly.

### SUMMARY OF THE INVENTION

In the case of a pump dispenser, the advantages are achieved by the features of the independent claims. Developments and/or advantageous alternative embodiments form the subject-matter of the dependent claims.

The invention comprises a spring that is made of a plastic material and has a plurality of rings arranged one above the other, which are in each case interconnected by at least one first connecting web. This embodiment of the spring makes it possible for the rings and ring segments to be able to bend, and for the spring to be able to be compressed by an axial force and to return to its basic position when the force is removed, even though it is made of plastic. The connecting webs may be of the same length or can vary in their length, in order to adapt the spring travel to the required pump stroke. The pump dispenser is used to convey liquids from a container, it being possible for the viscosity of the liquid to vary, as long as the liquid remains pumpable. In addition to an aqueous liquid, the liquid can thus also be, for example, a cream or a gel.

In one embodiment of the invention, the rings are oriented horizontally, vertically or obliquely to the horizontal. The vertical and oblique orientation of the rings enables an enlarged spring travel of the spring.

In another embodiment of the invention, rings lying one above the other are interconnected by a first and a second connecting web. This results in a particularly stable spring, which is advantageous when the filling material to be pumped has an increased viscosity.

It has proven expedient if adjacent first and second connecting webs arranged one above the other are offset by 90 degrees. As a result, the rings can bend out of the horizontal plane sufficiently in order to enable a pump stroke downwards and to produce a sufficient return force in order to be able to suck liquid into the metering chamber.

The first and second connecting webs are expediently diametrically opposed on the ring or the ring segment. As a result, the spring is constructed symmetrically and receives a return force distributed uniformly over the circumference of the rings. A diametrical arrangement is sometimes not possible on the ring segments. However, this is compensated by connecting webs which are arranged on the open edges of the ring segments.

In another embodiment of the invention, the spring is accommodated outside the metering chamber in the housing. As a result, the spring is separated from the liquid and uninfluenced by the liquid. This is important in that a plastic material of the spring cannot be damaged by the liquid, for example cannot become brittle. In addition, the spring surrounds the metering chamber and is thereby forcibly guided, which leads to a reliable function of the spring.

In a further embodiment of the invention, the spring has at least one ring segment in addition to the rings, the at least one ring segment forming a recess. A plurality of ring segments can also be arranged on the spring one above the another, as a result of which the recess is enlarged. Components of the pump dispenser, for example the dispensing channel, can be positioned in the recess.

Since at least one distance is provided between vertically oriented rings of a horizontal plane, which distance forms the recess or a part of the recess, the recess, described in the last paragraph, can also be provided in the embodiment of the spring having vertically oriented rings.

In a further embodiment of the invention, the dispenser opening is provided on the housing. As a result, the dispenser opening does not move with the pump head. The exiting liquid therefore does not miss its target (for example the hand of a user), and the surroundings of the pump dispenser are not soiled by the liquid.

Expediently, the dispenser opening extends in part in a dispenser extension formed on the housing. As a result, the liquid exiting from the pump dispenser can be easily portioned into a hand or into a vessel. It is also conceivable that the dispenser opening ends at the housing wall and is provided with an atomizer. As a result, the pump dispenser can also be used as a pump spray.

In a further embodiment of the invention, the valve is realized by a first valve disk made of a plastic material, which disk is arranged between the upper side of an adapter inserted into the housing and the housing, and closes either the dispenser opening or the adapter in a liquid-tight manner. Since the first valve disk is made of a plastic material, it has the necessary flexibility to be able to bend and thereby release either the adapter or the dispenser opening. This can also be recycled together with the pump dispenser.

In a further embodiment of the invention, the adapter connects a rising tube, extending up to the base of the container, to the housing. The adapter acts as a reducer and allows the rising tube to be quickly connected to the housing. In addition, it is advantageous, for the rapid assembly of the pump dispenser, if the first valve disk can be inserted into the housing and then the adapter fixes the first valve disk to the housing.

The invention may also include a second valve disk made of a plastic material is held on the adapter on its underside, and the second valve disk closes a ventilation opening provided on the adapter and releases the ventilation opening when liquid is sucked into the metering chamber. As a result, no negative pressure can build up in the container, and the liquid can be conveyed uniformly by pushing down the pump head.

In another embodiment of the invention, the pump dispenser can interact with a slide arranged in the container and displaceable in the vertical direction, a storage chamber that can be changed in volume being formed between the adapter and the slide. This embodiment has the advantage that no air can penetrate into the storage chamber, and only liquid is located in the storage chamber. As a result, the liquid is stable for a particularly long time after the first actuation of the pump dispenser in the container. The slide is pushed upward by the air pressure after each pump stroke, and reduces the size of the storage chamber by the volume of the pump stroke.

It proves advantageous if the housing can be connected to the container by the adapter. As a result, after filling the container, the pump dispenser can be placed quickly and easily onto the container. The adapter can be snapped onto the housing and the container in a form-fitting manner.

In a further embodiment of the invention, the valve is realized by a third valve disk made of a plastic material, as an inlet valve, and a fourth valve disk made of a plastic material, as an outlet valve, the third disk closing or releasing an adapter inserted into the housing, and the fourth disk closing or releasing the dispenser opening. As a result, the valve function is apportioned between two valve disks, whereby this embodiment is very reliable. The third and fourth valve disks can also be produced from another flexible material, if the options for improved recycling do not take priority.

In a further embodiment, longitudinal ribs of different lengths are formed on the inside of the pump head, one of the longitudinal ribs interacting—by rotation of the pump head relative to the housing—with at least one stop formed on the housing. As a result, the height of the pump stroke can be easily adjusted, as a result of which different metering or dispensing volumes are possible, using the pump dispenser. A blocking of the pump stroke is also possible thereby, as a result of which transport locking is realized. It is also conceivable that the longitudinal ribs are all of the same length, and a plurality of stops of different heights are present on the housing.

Due to the fact that all components of the pump dispenser are made of a plastic material, the pump dispenser can be recycled without separation steps. This is in particular the case when all components of the pump dispenser and the container are made of the same a plastic material.

A further aspect of the invention relates to a pump container comprising a pump dispenser according to the above description and a container on which the pump dispenser can be placed. As a result, the pump dispenser and the container can be sold ready filled and assembled.

In one embodiment of a pump container, the pump dispenser interacts with a slider arranged in the container and displaceable in the vertical direction, a storage chamber that can be changed in the volume being formed between the adapter and the slide. As described further above, the storage chamber remains free of air and the liquid present in the storage chamber is stable for a particularly long time. This embodiment is therefore particularly suitable for cosmetic products such as skin creams and other oxygen-sensitive liquids.

A further aspect of the invention relates to a pump dispenser which is characterized in that the valve is realized by a first valve disk which is arranged between the upper side of an adapter inserted into the housing and the housing, and closes either the dispenser opening or the adapter in a liquid-tight manner. The valve function is therefore realized in a very simple, reliable and cost-effective manner.

A further aspect of the invention relates to a pump dispenser which is characterized in that the dispenser opening is provided on the housing. As already described above, this makes the pump dispenser very user-friendly, because the dispenser opening does not move during the pumping and the metered liquid can be applied in a targeted manner.

The dispenser opening may be provided in a dispenser extension formed on the housing, in order to be able to dispense the liquid into the hand of a user or into a vessel in a targeted manner.

Another aspect of the invention relates to a pump dispenser which is characterized in that longitudinal ribs of different lengths are formed on the inside of the pump head, one of the longitudinal ribs interacting—by rotation of the pump head relative to the housing—with at least one stop formed on the housing. The longitudinal ribs enable the pump stroke, and thus the metered liquid volume, to be adjusted intuitively by simply rotating the pump stroke. Transport locking can also be realized as a result.

### BRIEF DESCRIPTIONS OF THE DRAWINGS

Further advantages and features become apparent from the following description of two embodiments of the invention, with reference to the schematic drawings, in which drawings, which are not true to scale:

FIG. 1: is a side view of a pump dispenser placed on a container;

FIG. 2: is another side view of the pump dispenser;

FIG. 3: is an isometric view of a spring for resetting the pump head of the dispenser, in a first embodiment;

FIG. 4: is an isometric view, obliquely from below, of a housing;

FIG. 5: is an isometric view, obliquely from above, of the housing;

FIG. 6: is a first longitudinal sectional view through the pump dispenser;

FIG. 7: is a second longitudinal sectional view through the pump dispenser from FIG. 6;

FIG. 8: is a first longitudinal sectional view through an alternative pump dispenser;

FIG. 9: is a second longitudinal sectional view through the alternative pump dispenser from FIG. 8;

FIG. 10: is a sectional view through a third embodiment of the pump dispenser;

FIG. 11: is an isometric view of the spring in a second embodiment; and

FIG. 12: is an isometric view of the spring in a third embodiment.

### DETAILED DESCRIPTION OF THE INVENTION

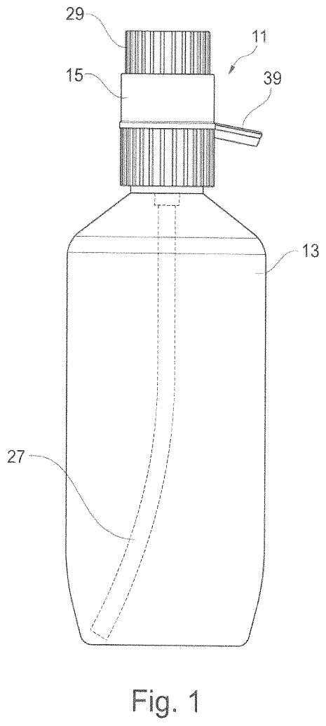

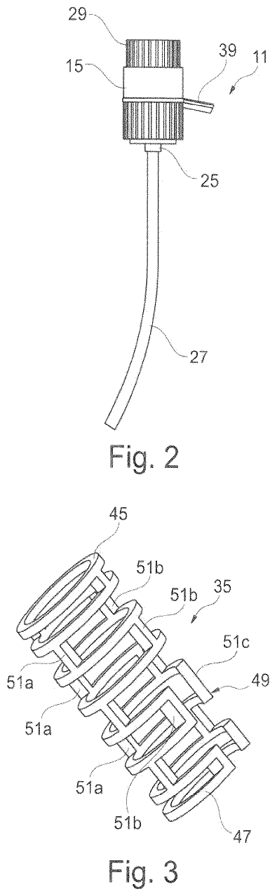

FIGS. 1, 2, 6 and 7 show a pump dispenser, which is denoted as a whole by the reference sign 11. The pump dispenser 11 can be placed onto a container 13, for example a bottle 13. The combination of the pump dispenser 11 and the container 13 is referred to as the pump container 14. The dispenser 11 has a housing 15, by which it is fastened to the container 13. The fastening can take place, for example, in a known manner by an internal thread 17 which interacts with an external thread 19 formed on the container neck 21. A metering chamber 23 is formed in the housing 15, in which metering chamber the quantity of liquid is sucked out of the container 13 and is then conveyed to the outside. The volume of the metering chamber 23 corresponds to the liquid volume which is removed from the container 13 during a pump stroke. The metering chamber 13 can also be regarded as a piston chamber.

An adapter 25 is held on the underside of the housing 15 in a form-fitting manner. The adapter 25 serves as a reducer and connects a rising tube 27 to the metering chamber 23. The container 13 with the dispenser 11 can be completely emptied via the rising tube 27, using the metering dispenser 11. A pump head 29 is movably arranged on the upper side of the housing. The pump head 29 can be moved up and down along the longitudinal axis 31 of the pump dispenser 11, between a first and a second position, whereby the pump stroke can be carried out. In the first position, the pump head 29 is at the highest point, from which it can be pushed downwards into the second, lowest position.

A piston 33 is secured to the pump head 29 and can be moved up and down together with the pump head 29 in the metering chamber 23. The piston 33 seals the metering chamber 23 at the top, in a liquid-tight manner. A spring 35 is arranged between the housing 15 and the pump head 29. The spring 35 returns the pump head 29 to the first position after it has been pushed into the second position.

The conveyed liquid leaves the pump dispenser 11 from a dispenser opening 37. the dispenser opening 37 extends in part on the outside of the metering chamber 23, and in part in a dispenser extension 39. In contrast to the prior art, the dispenser opening 37 or the dispenser extension 39 is not provided on the pump head 29, but rather on the housing 15.

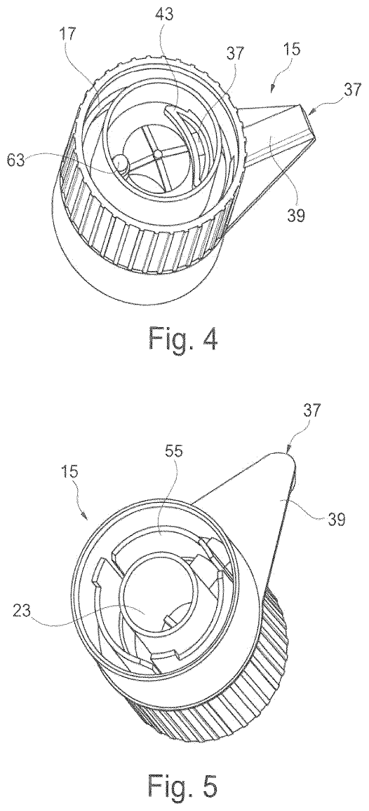

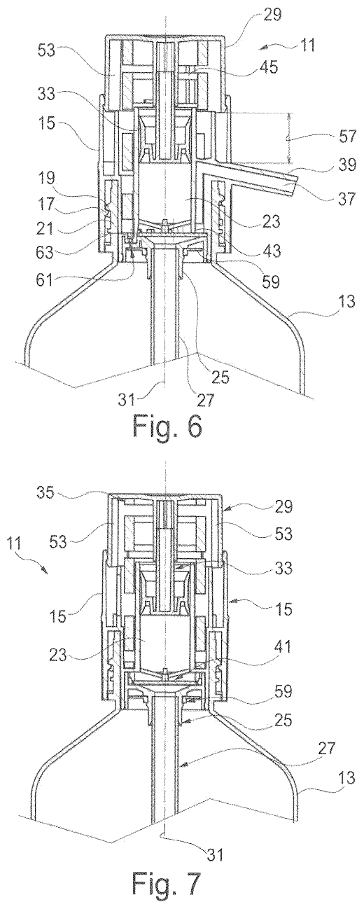

A valve defines the conveying direction of the liquid from the rising tube 27 via the metering chamber 23 into the dispenser opening 37. The valve blocks conveying in the reverse direction. As a result, the liquid can be conveyed into the dispenser opening 37 in pump strokes. In a first embodiment according to FIGS. 6 and 7, the valve is realized by a first valve disk 41, which is made of a plastic material. The first valve disk 41 is inserted between the adapter 25 and the underside of the metering chamber 23, and closes the metering chamber 23 with respect to the adapter 25. The valve disk 41 rests on the underside of the metering chamber 23 on a sickle-shaped shoulder 43, which shoulder 43 surrounds the dispenser opening 37 (FIG. 4).

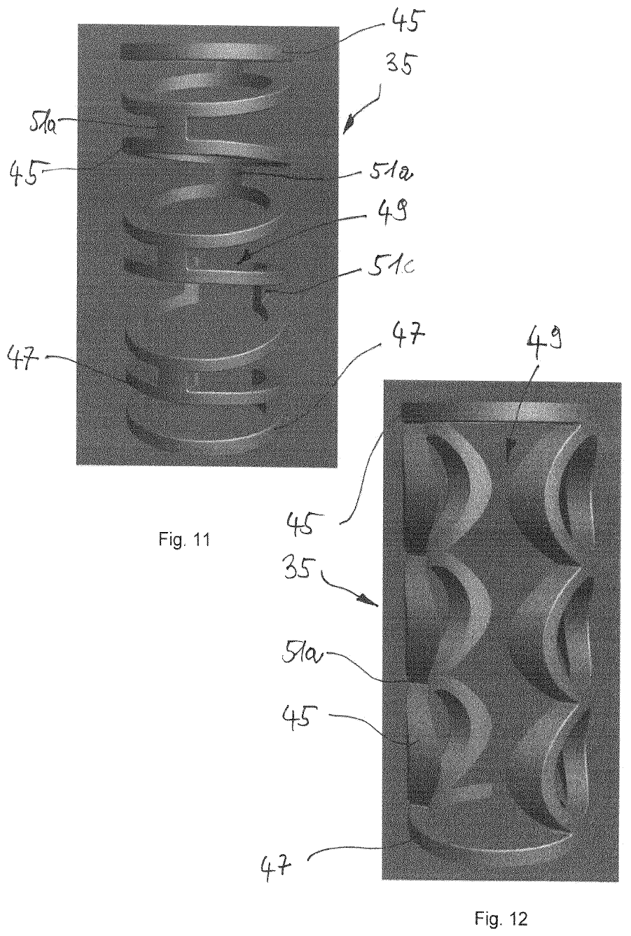

The spring 35 is made entirely of a plastic material and has a plurality of rings 45 arranged one above the other, and optional ring segments 47. The ring segments 47 are therefore present on the spring 35, such that there is space in a recess 49 of the spring 35 for the part of the dispenser opening 37 which extends along the metering chamber. Adjacent rings 45 are connected by a first and second diametrically arranged connecting web 51a, 51b. Adjacent first and second connecting webs 51a, 51b lying on top of one another are offset from one another by 90 degrees. This arrangement enables a resilient bending of the rings 45 or the ring segments 47. Additional third connecting webs 51c are also present between the ring segments 47, in order to form the recess 49. A first embodiment of the spring 35 is shown in FIG. 3. FIGS. 11 and 12 show a second and third embodiment of the spring 35. In contrast to the prior art, the spring 35 does not come into contact with liquid, since it is arranged outside the metering chamber 23 and quasi surrounds the metering chamber 23. Furthermore, the spring penetrates the pump head 29, as a result of which the uppermost ring 45 is arranged outside the pump head 29.

As shown in FIG. 11, adjacent rings 45 can also be connected only by a connecting web 51a. In order to increase the spring travel between two adjacent rings 45 or ring segments 47, the rings or ring segments can also be inclined relative to the horizontal. The outermost ring 45 and the outermost ring segment 47 are oriented horizontally, in order to rest flat on the pump head 29 or the housing 15. Only on the recess are third connecting webs 51c also arranged, in addition to the first connecting webs 51a, in order to close the ring segments 47.

The rings 45 lying between the outermost ring 45 and the outermost ring segment 47 can also be oriented vertically (FIG. 12). The contact of adjacent rings 45 forms the connecting webs 51a. The distance between two rings which lie in a horizontal plane forms the recess 49. As FIG. 12 shows, a plurality of rows of vertical rings arranged one above the other can be provided. If these rows are spaced apart from one another, this distance can form the recess 49. It would also be conceivable for two adjacent rows of vertical rings 45 to touch one another. The vertical rings 45 generate a particularly large spring travel for the spring 35.

Longitudinal ribs 53 of different lengths are formed on the inside of the pump head 29. Stops 55 are provided on the inside of the housing 15 (FIG. 5), which stops limit the pump stroke, since one of the longitudinal ribs 53 strikes a stop 55. The pump stroke 57 is shown by the double arrow. By rotating the pump head 29, one of the longitudinal ribs 53 comes up against the stop, and the pump stroke 57 has a certain height of the pump stroke 57 depending on the length of the longitudinal rib 53. As a result, the metering volume of the liquid can be adjusted. The pump stroke can also be set to 0, as a result of which the pump dispenser 11 can be closed.

In order for no negative pressure to arise in the container 13 during pumping, ventilation on the pump dispenser is provided. For this purpose, a second valve disk 59 made of a plastic material is attached to the underside of the adapter 25. The second valve disk 59 closes a ventilation opening 61 provided on the adapter 25 and a further ventilation opening 63 provided on the housing. If a negative pressure arises in the container 13, the second valve disk 59 is pressed by the atmospheric pressure until the pressure difference is compensated. As a result, the liquid can be uniformly conveyed by the pump dispenser 11.

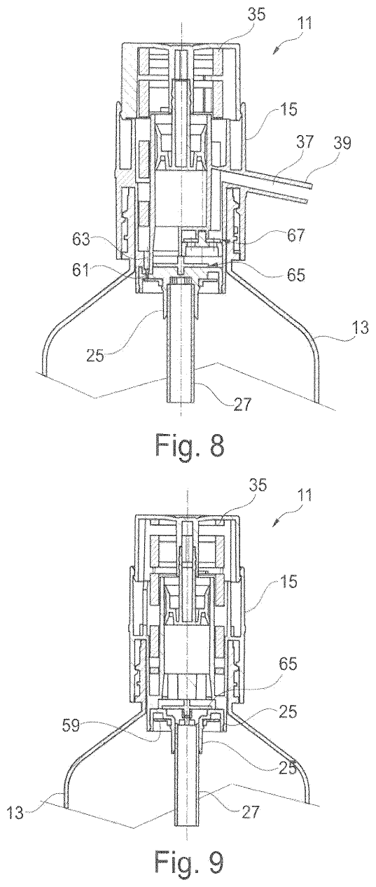

FIGS. 8 and 9 show an alternative embodiment of the valve function. For this purpose, a third valve disk 65 and a fourth valve disk 67, each made of a plastic material, are provided. The third valve disk 65 serves as an inlet valve into the metering chamber 23. In the suction cycle, the third valve disk 65 opens the adapter 25, and in the pressure cycle the third valve disk 65 closes said adapter. The fourth valve disk 67 serves as an outlet valve out of the metering chamber 23: In the suction cycle, the fourth valve disk 67 closes the dispenser opening 37, and in the pressure cycle the fourth valve disk 67 opens said dispenser opening 37.

The pump dispenser 11 and the container 11 are made completely metal-free, and it is even possible to produce all components from the same a plastic material; such as PP or PET. This ensures the recyclability of the entire arrangement, and the pump dispenser 11 can be disposed of and recycled together with the container. It is noteworthy that the spring 35 and the valve disks 41, 59, 65 and 67 are made of a plastic material. In pump dispensers according to the prior art, a metal spring and metal balls are usually installed as valves.

The pump dispenser 11 functions as follows:

The pump head 29 is located in the first position. It is pushed downwards from said position, as a result of which the piston 33 is also displaced downwards in the metering chamber 23. During this pressure cycle, the first valve disk 41 closes the adapter 25 or the rising tube 27, and the liquid is discharged via the dispenser opening 37. In the pressure cycle, the first valve disk 41 is deformed such that it is lifted off the shoulder 43 in part, and thereby releases the dispenser opening 37. The pressure cycle is ended in the second position of the piston 33. A prerequisite for liquid conveying is that the metering chamber 23 is already filled with liquid. Otherwise, the pump head 29 must be operated until the metering chamber 23 is filled.

When the piston 33 is displaced by the spring 35 into its initial position (first position), the first valve disk 41 releases access to the rising tube 27 and liquid is sucked into the metering chamber 23. The sealing effect results from the interaction of the first valve disk 41 with the adapter 25 and the shoulder 43.

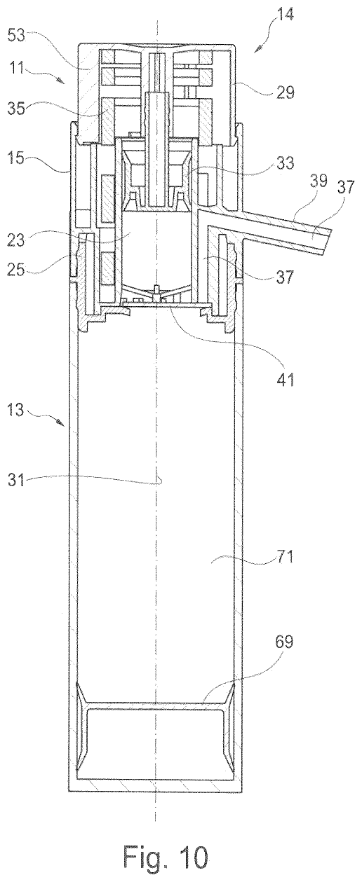

In a further embodiment according to FIG. 10, a slide 69 is arranged in the container. The slide 69 is displaceable along the longitudinal axis 31 in the container 13, and slides along the container wall in a liquid-tight manner. A storage chamber 71, in which the liquid is located, is formed between the adapter 25 and the slider 69. At each pump stroke 57, the slide 69 moves upward according to the liquid volume removed. In order that the air pressure can push the slide 69 upwards, the container must have a compensation opening below the slide 69. This embodiment makes it possible for the storage chamber 71 to be free of air. As a result, oxygen-sensitive filling materials are stable for a long time after the first use of the pump container 14, since they do not come into contact with atmospheric oxygen. The adapter 25 is configured to be latchable to the container 13 and the housing 15 in a form-fitting and liquid-tight manner, as is shown in FIG. 10.

All components of the pump dispenser and the container 13 can be made of the same a plastic material. This ensures recycling of the entire composition. Due to its design with rings 45 and connecting webs 51, the spring 35 ensures the return of the pump head 29 even after frequent use, even though it is made of a plastic material. The valve and ventilation function having a first or second valve disk 41, 59 constitutes a further special feature of the pump dispenser 11. It is particularly practical that the dispenser opening 37 does not move together with the pump head 29, but is provided on the stationary housing 15. It is also conceivable that the dispenser opening 37 is designed as an atomizer and the pump dispenser 11 thus has a liquid spraying function. The size of the metering volume or the blocking of the pump stroke 57 can be adjusted by rotating the pump head 29 relative to the housing 15, since the longitudinal ribs 53 are of different lengths.

1. A pump dispenser for a metered removal of a liquid from a container onto which the pump dispenser can be placed, comprising:
a housing configured to be placed on the container, the housing defining a metering chamber;
a pump head configured to be moved up and down relative to the housing along a longitudinal axis of the pump dispenser between a first and a second position to carry out a pump stroke;
a piston secured to the pump head and movable in the metering chamber to convey the liquid;
a dispenser opening connected to the metering chamber through which metered liquid can leave the pump dispenser;
a spring made of plastic configured to reset the pump head relative to the housing, the spring having a plurality of rings arranged one over another, each connected together by at least one connecting web; and
a valve defining a conveying direction of the liquid from the container into the dispenser opening, the valve configured to block a conveying process in an opposite direction.

2. The pump dispenser according to claim 1, wherein the plurality of rings are oriented horizontally, vertically or at an angle to horizontal.

3. The pump dispenser according to claim 1, wherein the plurality of rings lying one above the other are interconnected by first and second connecting webs.

4. The pump dispenser according to claim 3, wherein adjacent first and second connecting webs arranged one above the other are offset by 90 degrees.

5. The pump dispenser according to claim 4, wherein the first and second connecting webs are diametrically opposed to the respective ring of the plurality of rings.

6. The pump dispenser according to claim 1, wherein the spring is outside the metering chamber, in the housing.

7. The pump dispenser according to claim 1, wherein the spring has at least one ring segment in addition to the plurality of rings, the at least one ring segment forming a recess.

8. The pump dispenser according to claim 7, wherein at least one distance is provided between vertically oriented rings of a horizontal plane, said distance forming the recess or a part of the recess.

9. The pump dispenser according to claim 1, wherein the dispenser opening is provided on the housing.

10. The pump dispenser according to claim 1, wherein the dispenser opening extends in part in a dispenser extension formed on the housing.

11. The pump dispenser according to claim 1, wherein the valve comprises a first valve disk made of plastic, the first valve disk is arranged between the upper side of an adapter inserted into the housing and the housing, and closes either the dispenser opening or the adapter in a liquid-tight manner.

12. The pump dispenser according to claim 11, wherein the adapter connects a rising tube, extending to the base of the container, to the housing.

13. The pump dispenser according to claim 11, further comprising a second valve disk made of plastic and held on the adapter on its underside, the second valve disk closing a ventilation opening on the adapter and releasing the ventilation opening when liquid is sucked drawn into the metering chamber.

14. The pump dispenser according to claim 1, wherein the pump dispenser is configured to interact with a slide arranged in the container and displaceable in a vertical direction, a storage chamber configured to be changed in a volume formed between the adapter and the slide.

15. The pump dispenser according to claim 14, wherein the housing is configured to be connected to the container by the adapter.

16. The pump dispenser according to claim 1, wherein the valve comprises a first valve disk made of plastic, forming an inlet valve, and a second valve disk made of plastic forming an outlet valve, the first disk closing or releasing the adapter inserted into the housing, and the second disk closing or releasing the dispenser opening.

17. The pump dispenser according to claim 1, further comprising a plurality of longitudinal ribs of different lengths formed on an inside of the pump head, one of the plurality of longitudinal ribs interacting, by rotation of the pump head relative to the housing, with at least one stop formed on the housing.

18. The pump dispenser according to claim 1, wherein the housing, pump head, piston, and valve of the pump dispenser are made of plastic.

19. A pump container, comprising:
a pump dispenser comprising:
a container; and
a pump dispenser comprising:
a housing configured to be placed on the container, the housing defining a metering chamber;
a pump head configured to be moved up and down relative to the housing along a longitudinal axis of the pump dispenser between a first and a second position to carry out a pump stroke;
a piston secured to the pump head and movable in the metering chamber to convey the liquid;
a dispenser opening connected to the metering chamber through which metered liquid can leave the pump dispenser;
a spring made of plastic configured to reset the pump head relative to the housing, the spring having a plurality of rings arranged one over another, each connected together by at least one connecting web; and
a valve defining a conveying direction of the liquid from the container into the dispenser opening, the valve configured to block a conveying process in an opposite direction; and
a container on which the pump dispenser can is configured to be placed.

20. The pump container of claim 19,
wherein the pump dispenser interacts with a slide arranged in the container and displaceable in a vertical direction, a storage chamber that can be changed in volume between the adapter and the slide.

21. The pump container according to claim 20, wherein the housing is connected to the container by the adapter.

22. A pump dispenser for the metered removal of a liquid from a container onto which the pump dispenser can be placed, comprising:
a housing configured to be placed on the container and defining a metering chamber;
a pump head configured to be moved up and down relative to the housing along a longitudinal axis of the pump dispenser between a first and a second position to carry out a pump stroke,
a piston secured to the pump head and moveable in the metering chamber to convey the liquid,
a dispenser opening connected to the metering chamber through which metered liquid can leave the pump dispenser,
a spring that resets the pump head relative to the housing; and
a valve that defines a conveying direction of the liquid from the container into the dispenser opening and that blocks a conveying process in an opposite direction,
the valve comprising a first valve disk that is arranged between an upper side of an adapter inserted into the housing and the housing, and that closes either the dispenser opening or the adapter in a liquid-tight manner.

23. A pump dispenser for metered removal of a liquid from a container, on which container the pump dispenser can be placed, comprising:
a housing configured to be placed on the container and defining a metering chamber;
a pump head configured to be moved up and down relative to the housing along a longitudinal axis of the dispenser between a first and a second position in order to carry out a pump stroke;
a piston secured to the pump head and configured to be moved in the metering chamber in order to convey the liquid;
a dispenser opening connected to the metering chamber, through which metered liquid can leave the pump dispenser,
a spring that resets the pump head relative to the housing; and
a valve that defines the conveying direction of the liquid from the container into the dispenser opening and that blocks a conveying process in the opposite direction, wherein the dispenser opening is provided on the housing.

24. The pump dispenser according to claim 23, wherein the dispenser opening is provided in a dispenser extension formed on the housing.

25. A pump dispenser for metered removal of a liquid from a container on which the pump dispenser can be placed, comprising:
a housing configured to be placed on the container and forming a metering chamber;
a pump head movable up and down relative to the housing along a longitudinal axis of the dispenser between a first and a second position in order to carry out a pump stroke;
a piston secured to the pump head and movable in the metering chamber to convey the liquid;
a dispenser opening connected to the metering chamber through which metered liquid can leave the pump dispenser;
a spring that resets the pump head relative to the housing; and
a valve that defines a conveying direction of the liquid from the container into the dispenser opening and blocks a conveying process in an opposite direction; and
longitudinal ribs of different lengths formed on an inside of the pump head, one of the longitudinal ribs interacting—by rotation of the pump head relative to the housing with at least one stop formed on the housing.
